(19) United States
(12) Patent Application Publication
(10) Pub. No.: US 2016/0085846 A1
(43) Pub. Date: Mar. 24, 2016

(54) SYSTEM FOR FACILITATING THE COLLABORATIVE CREATION OF MUSIC

(71) Applicant: David Robert SMITH, Toronto (CA)

(72) Inventor: David Robert Smith, Toronto (CA)

(21) Appl. No.: 14/889,024

(22) PCT Filed: May 13, 2014
(86) PCT No.: PCT/CA2014/000421

§ 371 Date: Nov. 4, 2015

Related U.S. Application Data
(60) Provisional application No. 61/822,693, filed on May 13, 2013.
(60) Provisional application No. 61/952,330, filed on Mar. 13, 2014.

(51) Int. Cl. G06F 17/30; G07C 13/00; G10H 1/00

(52) U.S. Cl. CPC G06F 17/30598; G10H 1/0033; G06F 17/30958; G06F 17/30876; G06F 17/30749; G07C 13/00; G10H 2240/175; G10H 2240/135; G10H 2240/081; G10H 2240/095; G10H 2230/015

(57) ABSTRACT

The system comprises a taxonomy for classifying a music recording and can further comprise a computing functionality. The functionality can: provide for the dissemination of identities of recordings that have been classified in accordance with the taxonomy and the classifications thereof; allow users to identify recordings that have been classified in accordance with the taxonomy; allow user to classify recordings in accordance with the taxonomy; permit users to identify music projects and to associate music recordings to projects; in respect of projects to which recordings have been associated having differing proprietors, provide a mechanism by which those proprietors can submit votes on a division of rights in a Master defined by those recordings; provide for dissemination of the recordings and the classifications by a scatterplot graph wherein each point represents a music recording, each of the dimensions of the plot being associated with a relatively highly-variable characteristic of the recording.

### FIELD OF THE INVENTION

The invention relates to the music industry.

### BACKGROUND OF THE INVENTION

The online revolution has had a profound effect on many industries. One industry that has certainly been impacted is the music industry, which has seen its historical revenue model collapse. The loss of well-funded promoters has shifted the costs of music creation to the creative individuals themselves, and there has been an insufficient compensating shift in revenue. While the costs of music distribution have fallen, the industry has been slow to share those cost savings with musicians. Moreover, the costs of developing musical talent and creating new music have not fundamentally decreased, and this has had impacts upon the sustainable rate of new music creation.

### SUMMARY OF THE INVENTION

A system for facilitating the collaborative creation of music forms one aspect of the invention. The system comprises a taxonomy for classifying a music recording.

According to another aspect, the system can further comprise a computing functionality that provides for the dissemination of identities of recordings that have been classified in accordance with the taxonomy and the classifications thereof.

According to another aspect, the functionality can allow users to identify recordings that have been classified in accordance with the taxonomy.

According to another aspect, the functionality can allow users to classify recordings in accordance with the taxonomy.

According to another aspect, the computing functionality can be accessible via a communications network and provide for the dissemination of identities and classifications by the communications network.

According to another aspect, the recordings can be classified by proprietor and one or more of title, presence, author, genre, instrument, license type, sample rate, time signature, file format type, mode, key, tempo, musical influences and the type of digital audio device(s) used in production.

According to another aspect, the classifications can include, for presence, notation and performance.

According to another aspect, the recordings can include compositions, arrangements and combinations thereof.

According to another aspect, the functionality can be further adapted to permit users to identify music projects and to associate music recordings to projects.

According to another aspect, the functionality can be further adapted to disseminate identities of projects and music recordings associated therewith.

According to another aspect, in respect of each project to which recordings have been associated having differing proprietors, the functionality can provide a mechanism by which those proprietors can submit votes on a division of rights in a Master defined by those recordings.

According to another aspect, the vote on a division of rights can be a vote for a portion of the rights in the Master to each of the voting proprietors.

According to another aspect, if the voting proprietors vote in unanimity on an allocation of rights, such voting result can be deemed to be a vote in favor of that allocation.

According to another aspect, if the voting proprietors vote in unanimity on an allocation of rights, such voting result is deemed to be a vote in favor of that allocation and the functionality creates a document evidencing an agreement thereby made reflecting such allocation.

According to another aspect, if the vote of the proprietors is not unanimous, the functionality can provide for a reconsideration step, wherein the facility: disseminates to the voting proprietors information on the allocations voted for by each proprietor along with a calculated allocation for each proprietor that is a reflection of prior votes; prompts each voting proprietor to select a choice from a group of choices including one or more of: (i) agree with the allocations voted for by any one of the other voting proprietors; and (ii) agree with the calculated allocation.

According to another aspect, the calculated allocation can be an average.

According to another aspect, the group of choices can also include one or more of: (i) vote in favor of the previous allocation by that proprietor; and (ii) enter a new allocation.

According to another aspect, the functionality can further provide for the dissemination of the recordings.

According to another aspect, the functionality can provide for a secure portal accessible via the Internet.

According to another aspect, the functionality can provide for dissemination of the details of the recordings and the classifications by a 2 or 3-dimensional scatterplot graph wherein each point represents a music recording, each of the dimensions of the plot being associated with a relatively highly-variable characteristic of the recording.

According to another aspect, the dimensions of the scatterplot graph can be selected from one or more of: time of creation, time of upload, last upload, number of downloads, number of times played, danceability, speechiness, liveness, acousticness, valence, energy, intensity, likes and degree of correlation to preferences.

According to another aspect, the functionality can allow for the points shown in the scatterplot graph to be filtered by one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, number of projects in which a recording is included, likes and degree of correlation to preferences.

According to another aspect, the appearance of the points in the scatterplot graph can vary as a function, which may be user-selectable, of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, number of projects in which a recording is included, likes and degree of correlation to preferences.

According to another aspect, selection of a point in the scatterplot graph can trigger one or more of a playback of the audio file(s) associated with the recording and a display of the details of the classification of the recording.

According to another aspect, the functionality can provide for dissemination of the details of the projects and the recordings associated therewith by a 2 or 3-dimensional scatterplot graph wherein the point are collections of icons, each collection representing a project, an icon being provided for each music recording associated to a project and each music recording desired for the project

According to another aspect, the graph dimension can be defined by relatively highly-variable characteristics of the points such as: time of creation, time of upload, last upload, last visit, energy, number of downloads, number of times played, danceability, speechiness, liveness, acousticness, valence, intensity, likes and degree of correlation to preferences.

According to another aspect, the points can be filtered by one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, likes and degree of correlation to preferences.

According to another aspect, the appearance of the icons in the scatterplot graph can vary as a function, which may be user-selectable, of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, likes and degree of correlation to preferences.

According to another aspect, the functionality can be further adapted to permit a person that has identified a project to define music recordings desired in respect of the project and a state of completion of the project is defined automatically as a function of the difference between the desired music recordings defined and the music recordings associated therewith.

According to another aspect, the functionality is further adapted to permit a person that has identified a project with which a music recording has been associated by another to dissociate that recording.

### DETAILED DESCRIPTION

### High Level Overview

### Classification System

One aspect of the invention is a system for classifying a music recording, whether it be a performance, a notation or a combination thereof.

### Computing Functionality

Another aspect of the invention is a computing functionality that is accessible by multiple users over a communications network. A portal in the nature of a website accessible by the Internet is one possible embodiment but others are possible.

### Identification and Classification of Recordings.

As one aspect, the computing functionality can allows users to identify recordings and classify same in accordance with the system. Users can identify a recording by, for example, uploading the recording to a portal or by providing a searchable name for the recording or a storage location therefor. The recording is classified, either manually, by the person identifying the recording, or automatically, by software working within the functionality. Typical classifications can include: presence [notation or performance], track type (melody, ostinato, harmony, etc.), author, proprietor, genre, state of completion, instrument, vocal type, license type, sample rate, bit depth, file format type, time signature, mode, key, tempo, energy, time of first upload, time of last upload, number of downloads, number of times played, danceability, speechiness, liveness, acousticness, valence, musical influences, time of creation, physical location of the author/producer/proprietor, and the type of digital audio device(s) used in production. Other data fields associated with a recording can include last visit, number of recent visits, number of plays, number of projects in which a recording is included, total visits and “likes”, all as discussed below. When the functionality is not embodied as a repository for the recordings, i.e. the recordings are not uploaded to the functionality, a searchable name and/or storage location would typically be provided.

### Identification of Projects

Another functionality is the identification of projects. Each project is a dataset containing data.

Users can identify a project by populating a new dataset with data. This will typically create a data field defined by the time of creation. Each project has a producer [typically the person who identifies the project] and has control over the dataset, as discussed below. The dataset of a project typically but not always commences with the assignment of a title and the association of a recording. The producer may also populate the record with a genre, a sample rate, a bit depth, file format type, the type of digital audio device(s) used in production, a listing of music recordings desired for contribution to the project, a license type, an indication if cash and/or royalties will be offered for collaborators, and a physical location of the producer. Other data fields associated with a project can include last association, last visit, total visits and “likes”.

### Association of Recordings to Projects

Another functionality is the association and disassociation of music recordings to projects. This can be done unilaterally, that is, a user may associate a music recording to a project, irrespective of the desires (stated or otherwise) of the producer of that project for a music recording of the same type [in which case, as suggested above, the producer may, if desired, disassociate any recording so assigned]. Alternatively, this can be done by an invitation sent by the producer, providing details of a suggested association which, if accepted by the recipient, can result in an association. Association of a recording to a project autopopulates an association field and a visit field of the project, if those fields are tracked in the embodiment.

### Dissemination of Details of Recordings

Yet another functionality is the dissemination of details of the recordings. In the context of a portal, the details can be disseminated to all visitors to the portal. Alternatively, the functionality can provide a social networking platform to permit users to create connections/friends and the details can be disseminated only to friends of the author of the recording.

The details can be disseminated in any searchable or viewable format. One advantageous format is a 2 or 3-dimensional scatterplot graph, wherein:
the points represent music recordings
the dimensions of the graph are defined by relatively highly-variable characteristics of the points such as: time of creation, time of upload, last upload, last visit, energy, number of downloads, number of times played, danceability, speechiness, liveness, acousticness, valence, intensity, likes and degree of correlation to preferences
the points can be filtered by the viewer by one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, number of projects in which a recording is included, likes and degree of correlation to preferences
the appearance of the points in the scatterplot graph varies as a function, which may be user-selectable, of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, number of projects in which a recording is included, likes and degree of correlation to preferences

### Dissemination of Details of Projects

Yet another functionality is the dissemination of details of the projects. In the context of a portal, the details can be disseminated to all visitors to the portal. Alternatively, the functionality can provide a social networking platform to permit users to create connections/friends and the details can be disseminated only to friends of the producer of the project. The details can be disseminated in any searchable or viewable format. One advantageous format is a 2 or 3-dimensional scatterplot graph, wherein:
the points are collections of icons, each collection representing a project
the graph dimensions are defined by relatively highly-variable characteristics of the points such as: time of creation, time of upload, last upload, last visit, energy, number of downloads, number of times played, danceability, speechiness, liveness, acousticness, valence, intensity, likes and degree of correlation to preferences
an icon is provided for each music recording associated to a project and each music recording desired for the project
the points can be filtered by the viewer by one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, likes and degree of correlation to preferences
the appearance of the icons in the scatterplot graph varies as a function, which may be user-selectable, of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, number of recent visits, total visits, state of completion, number of plays, likes and degree of correlation to preferences

### Dissemination of Recordings

As yet another function, the facility can provide for the dissemination of the recordings to users. One advantageous manner of said dissemination involves functionality which allows a viewer of a scatterplot graph to select a point or icon, which selection triggers one or more of: the playback of the audio file associated with the point; a display of the notation associated with the point; and a display of the details of the classification of the recording(s) represented by the point.

### Voting

As yet another functionality, in respect of each project to which recordings have been associated having differing proprietors, a mechanism is provided by which those proprietors can submit votes on a division of rights in a Master defined by those recordings. The vote on a division of rights can be a vote for a portion of the rights in the Master to each of the voting proprietors.

If the voting proprietors vote in unanimity on an allocation, such voting result can be deemed to be a vote in favor of that allocation. Moreover, use of the functionality can be limited to users that have previously agreed to be bound by certain contractual provisions, in which case, a vote in unanimity on an allocation can represent and result in an agreement of the proprietors and the functionality can create a document evidencing the agreement thereby made reflecting such allocation

If the vote of the proprietors is not unanimous, the functionality can provide for a reconsideration step, wherein the facility: disseminates to the voting proprietors, details of the allocations voted for by each proprietor along with a calculated allocation for each proprietor that is a reflection of prior votes; prompts each voting proprietor to select a choice from a group of choices including one or more of: agree with the allocations voted for by any one of the other voting proprietors; and agree with the calculated allocation. The calculated allocation can be an average. The group of choices also includes one or more of: vote in favor of the previous allocation by that proprietor; and enter a new allocation.

### BRIEF DESCRIPTION OF THE DRAWINGS

In the Figures, which show features of modules of a web portal adapted to carry out an embodiment of the invention, and of a mobile application similarly adapted to carry out an embodiment of the invention:

FIG. 1 is a view of an exemplary registration page

FIG. 2 is a view of an exemplary Project page

FIG. 3 is an enlarged view of a portion of FIG. 2;

FIG. 4 is a view of another exemplary Project page;

FIG. 5 is a view of a data entry block;

FIG. 6 is a view similar to FIG. 5 showing additional explanatory matter;

FIG. 7 is a view similar to FIG. 6 showing one of the options selected;

FIG. 8 is a view of a data block for the exemplary project Northern Light;

FIG. 9 is a listing of audio files associated to Northern Light;

FIG. 10 is a view of an exemplary file storage facility;

FIG. 11 is a view of an upload window;

FIG. 12 is a view similar to FIG. 9;

FIG. 13 is a view similar to FIG. 8;

FIG. 14 is a view similar to FIG. 13 showing additional selections activated;

FIG. 15 is an exemplary view of an “Invite Friend” page;

FIG. 16 is an exemplary view of an “Invite by Email” page;

FIG. 17 is an enlarged view of a portion of FIG. 2;

FIG. 18 is a view of a Project page shown to an Invitee;

FIG. 19 is a view showing text messaging functionality;

FIG. 20 is a view showing an audition functionality;

FIG. 21 is a view showing functionality associated with the “Post Open Position” facility;

FIG. 22 is a view showing further functionality associated with the “Post Open Position” facility;

FIG. 23 is a view of a Project page showing an “Open Position” flag

FIG. 24 is a list of Open Positions;

FIG. 25 is an Open Position page;

FIG. 26 is a view showing an application interface for the session player position for Northern Light;

FIG. 27 is a view of a Project Page showing a response flag;

FIG. 28 is a view of a response page;

FIG. 29 is a view of an audition facility provided for the response;

FIG. 30 is a view of the Project Page for Northern Light;

FIG. 31 is a view of the audio files associated to Northern Light;

FIG. 32 is a view of a timeline produced by the facility for Northern Light;

FIG. 33 is a view showing the Project Filters;

FIG. 34 is a view showing the Project Sort buttons;

FIG. 35 is a view of an exemplary Music Map;

FIG. 36 shows the results of the selection of an audio file on the Music Map;

FIG. 37 shows the results of the selection of the Audio Map function

FIG. 38 shows the result of the selection of the filter Genre

FIG. 39 shows the result when the file Harmony Cello is selected for audio match with Northern Light;

FIG. 40 is a view of another exemplary Music Map;

FIG. 41 is a view of a primary user interface;

FIG. 42 is a view of a modal window in a Public Archive; and

FIG. 43 is a view of a modal window in a Private Archive.

### GRANULAR DESCRIPTION OF EXEMPLARY MODULES

### Social Networking

In an exemplary module, social networking is incorporated to facilitate personal connections, conversations, exchange of information, sharing of work and other facets of collaborative endeavours.

A registration process for new users of the system [“customers”] automatically generates lists of suggested Contacts in a conventional manner, i.e. based on common data-points or data-sets drawn from multiple sources. Commonality can be parsed and calculated based on customers attending the same music school, having similar artistic influences and connections on other social networking sites such as FaceBook and LinkedIn, etc.

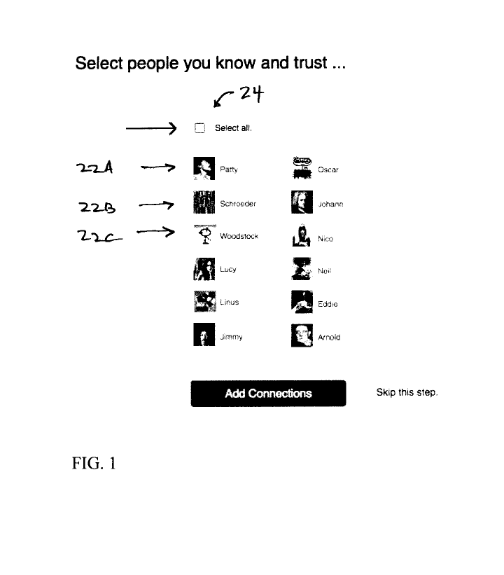

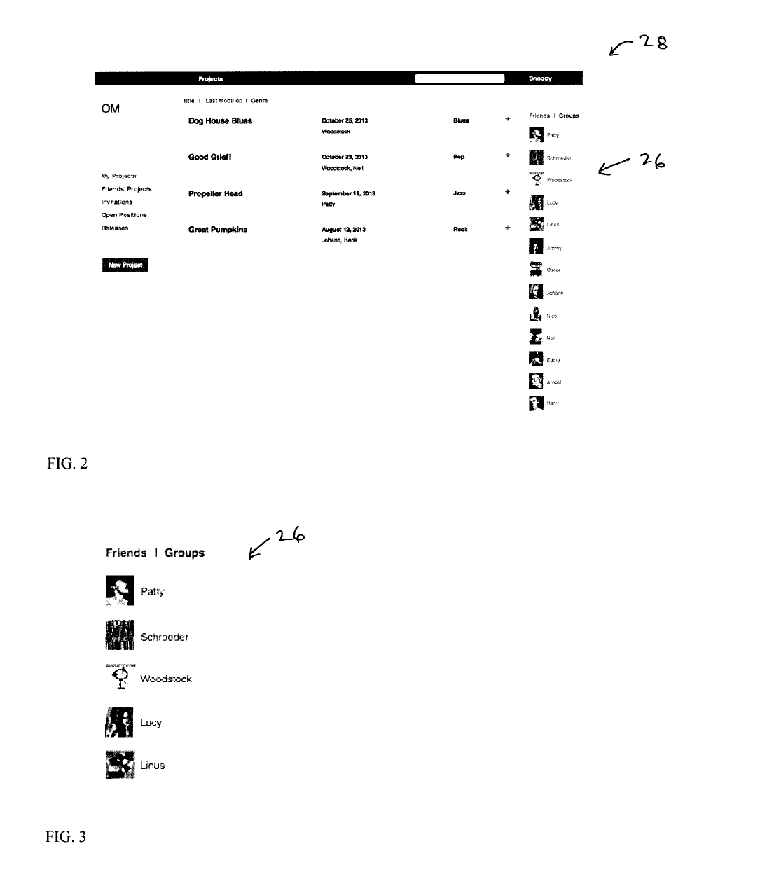

FIG. 1 is an example of a page in an exemplary registration process that shows a collection of images 22A, 22B, 22C, each representing a suggested contact. Selection of one of the suggestions, by selecting the image, or selection of all, via the Select All button 24, causes invitations to be sent by the module to the related contact. If the recipient accepts the invitation, a “Connection” is made and the recipient and sender each appear as Friends in a Friends List of the other. FIG. 2 shows an example of a Friends List 26 on a Project page 28 for the fictional customer, Snoopy. The Friends List is present on most pages of the site. FIG. 3 is a close-up of the Friends List 26.

### Project Management

The exemplary Project Management Module comprises the following functions:

| | |
|---|---|
| Create Project | File Synchronization |
| Upload files | Edit Project |
| Send Invitations | Timeline |
| Respond to Invitations | Comments |
| Posting an open position | Project Filters |
| Responding to an open position | Project Sort Buttons |
| Review Open Position | |

### Create Project

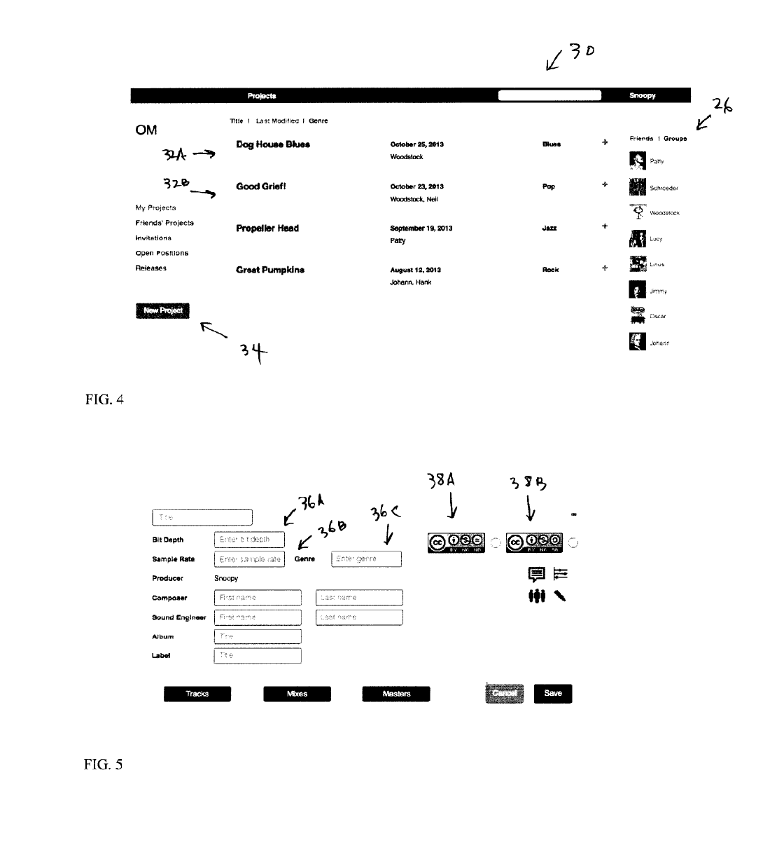

FIG. 4 is a page 30 showing Projects 32A,32B [Dog House Blues, etc.] for Snoopy in the exemplary Project Management Module.

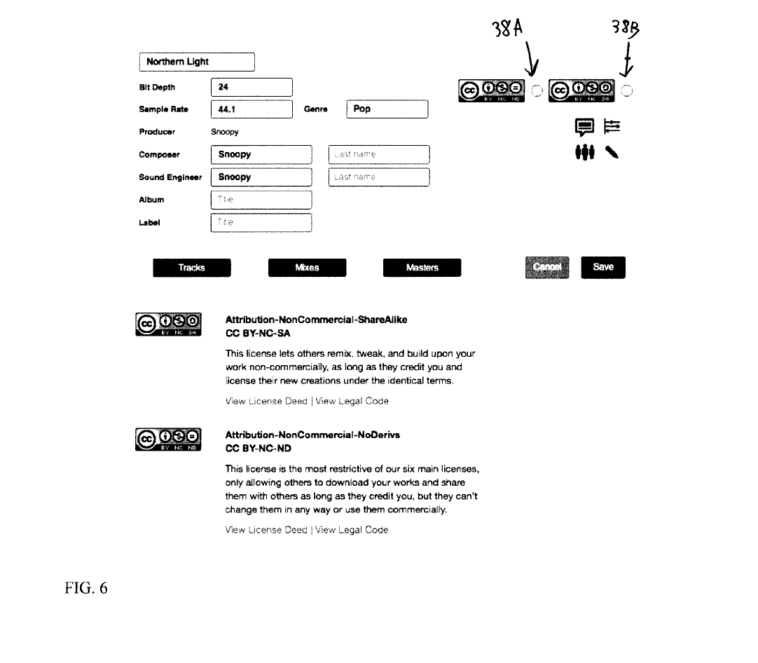

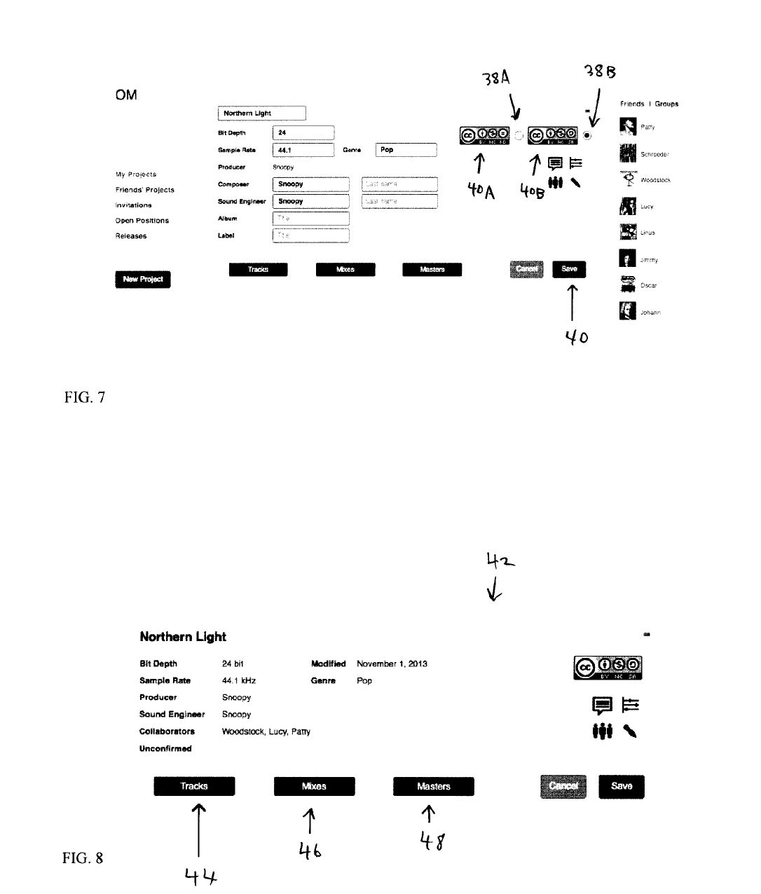

A user creates a new Project using a series of steps that include:
Clicking the New Project button 34, as shown in FIG. 4
Entering relevant metadata into empty data fields 36A, 36B, 36C in a dataset, as shown in FIG. 5
Selecting a Creative Commons license by selecting the associated button 38A, 38B, as shown by the sequence of FIG. 6 and FIG. 7; FIG. 7 shows button 38B populated, evidencing its selection
Clicking the Save button 40, also shown on FIG. 7.

Details of two specific Creative Commons licenses are available by selecting the icons 40A, 40B provided on the page, for ease of reference. Once the Save button is clicked, the new Project data is stored in the database. New Projects are represented by Project Icons 32A, 32B on Project Home Page, as shown on FIG. 4. Each Project Icon displays data such as: Title, Genre, Collaborators, Date Last Modified, etc.

### Uploading Audio Files

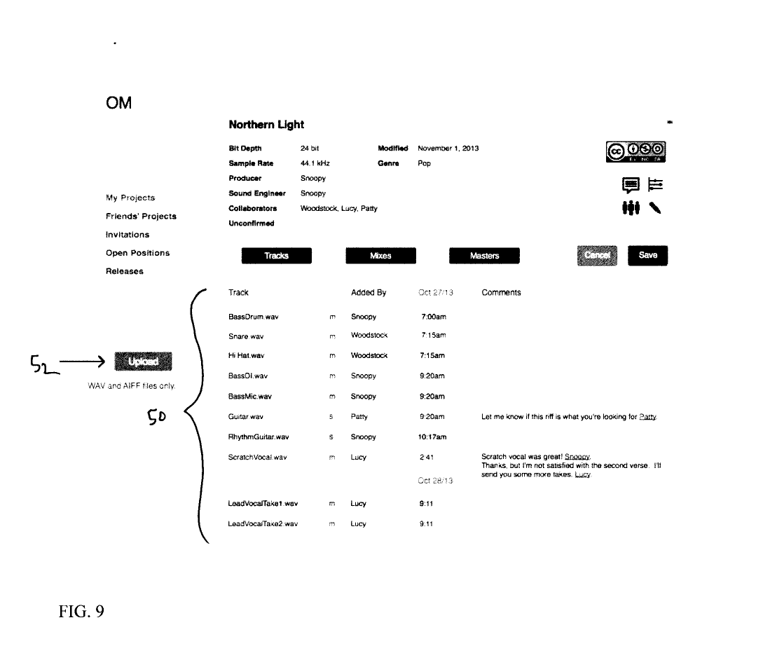

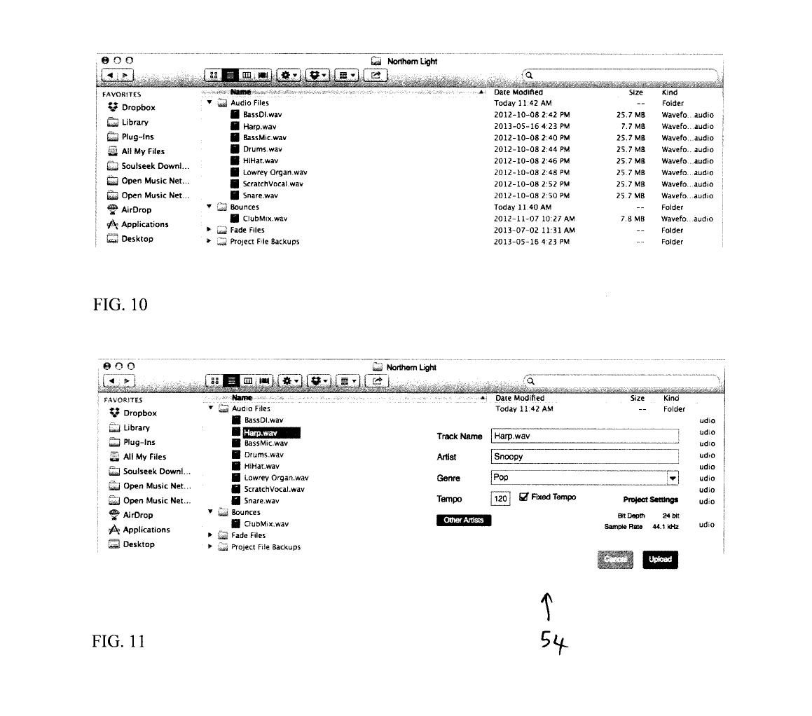

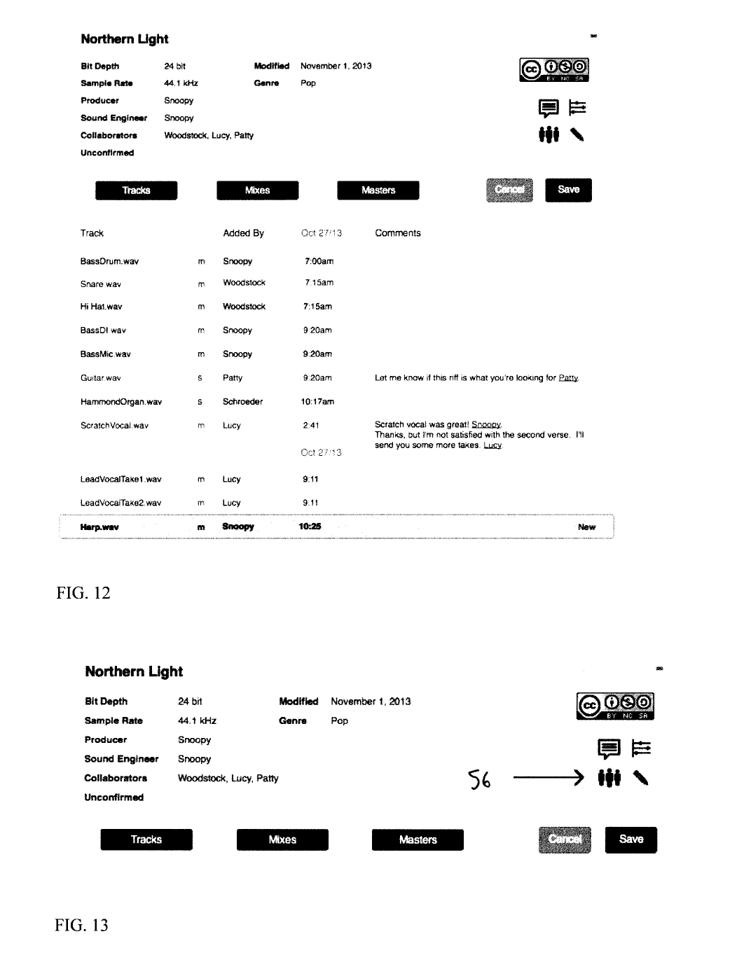

A customer associates audio files to a Project using a series of steps that include:
Clicking the Project Icon to reveal, as shown in FIG. 8, a display 42 of various metadata and functions, and then selecting the Tracks 44 or Mixes 46 or Masters 48 button
Clicking the Tracks or Mixes or Masters button reveals, as shown in FIG. 9, a list 50 of existing audio files associated to the Project as well as the Upload button 52
Clicking the Upload button 52 reveals the customer's stored audio files on any one of several client applications: eg. Windows, OSX, Linux, as shown in FIG. 10
Clicking an audio file reveals an Upload Window 54, as shown in FIG. 11, featuring the selected audio file's metadata and options for amending/adding to that metadata
Clicking the Upload button (see Upload Window above) uploads the selected file(s) to the Site's databases. Once on the Site, it is displayed as a new addition to the Project, as by FIG. 12, wherein the file Harp.wav which appears in the upload window 54 of FIG. 11 appears at the bottom of the list in FIG. 12

### Sending Invitations

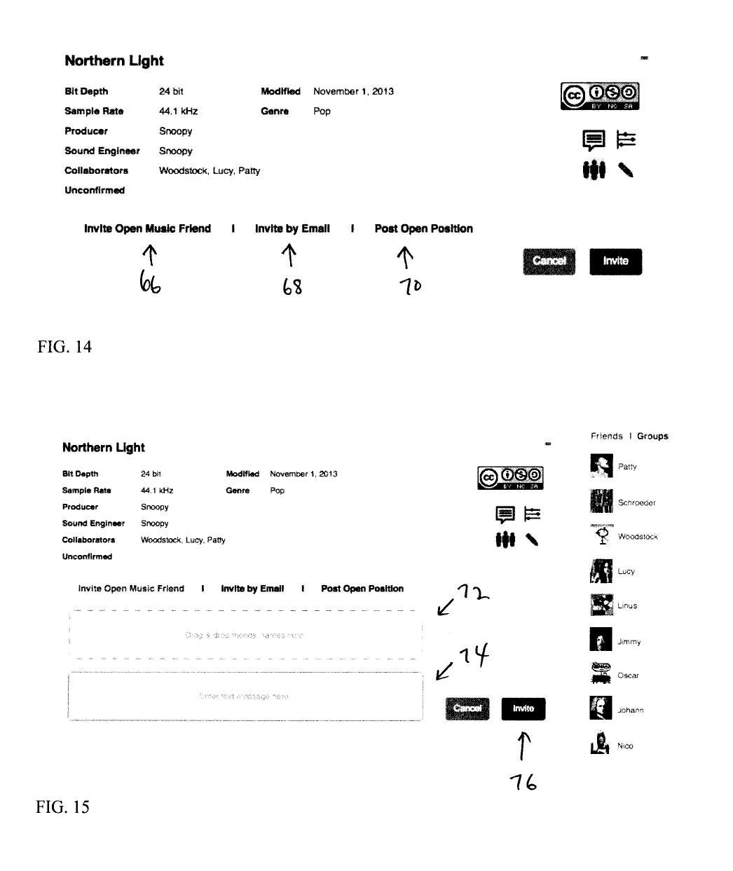

A customer can invite a collaborator to a Project using a series of steps that include:
Clicking a Project Icon 32A, 32B, etc. to reveal various metadata and functions, and then selecting the Collaborator Icon 56, as shown in FIG. 13
Clicking the Collaborator Icon reveals buttons for inviting collaborators, as shown in FIG. 14: “Invite Friend” 66, “Invite by Email” 68, and “Post Open Position” 70.

Clicking “Invite Friend” 66, opens: (i) a “drag & drop” field 72 that enables the customer to drag & drop Friends' images and names from a Friends List into the target field; (ii) a Comment field 74, so the customer can send the selected Friend(s) a message related to the Project, all as shown in FIG. 15.

Once the fields are populated, the customer can send the invitation(s) and message by clicking the Invite button 76.

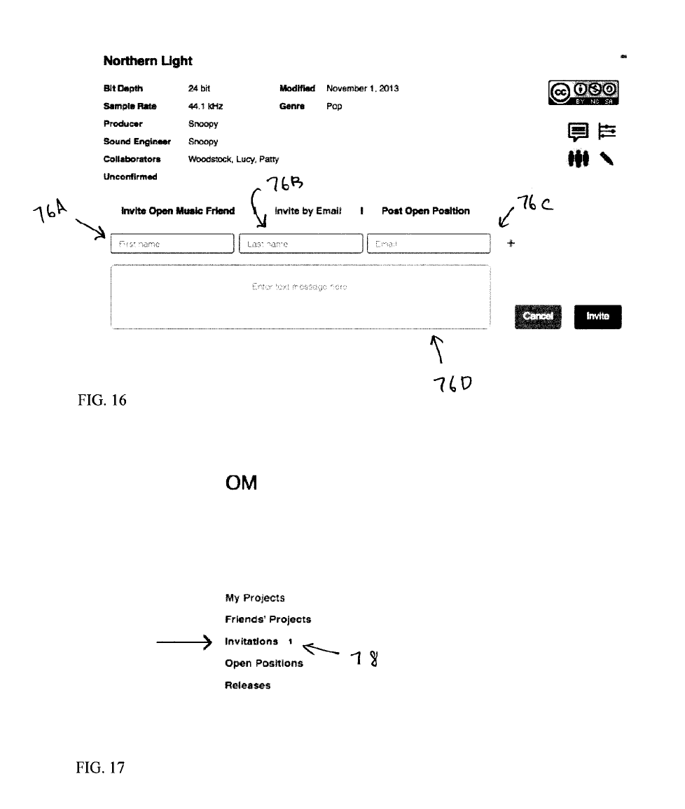

Clicking “Invite by Email” 68 opens text fields 76A-C to allow the customer to enter the required names and email addresses for collaborators who might not be included in the customer's Friends List on the site, as shown in FIG. 16. There is also a Comment field 76D, so the customer can send invitee(s) a message.

“Post Open Position” is discussed in following paragraphs.

### Responding to Invitations

An invitee can respond to an invitation to join a Project using a series of steps that depend on whether he or she is an existing customer of the system.

### Responding as a Customer

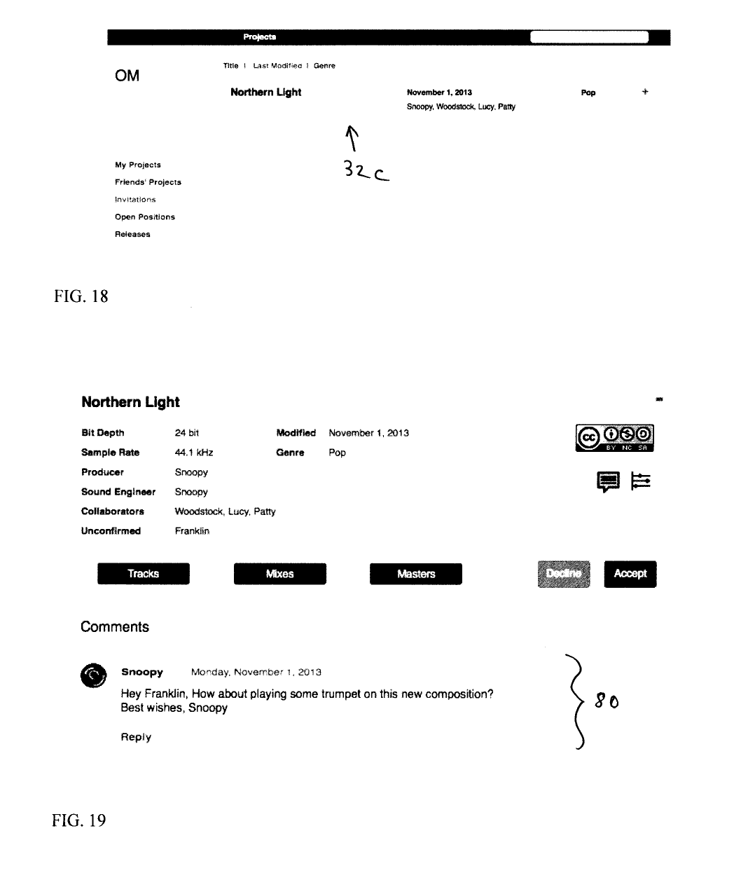

A customer receiving an invitation will receive an email with a link to the relevant Project, and also a notification on the site, namely, a flag 78 that there is a new Project invitation (see FIG. 17). When the customer clicks on the link in the email or on the Invitations Filter, the relevant Project will be displayed on the invitee's Project page (see FIG. 18).

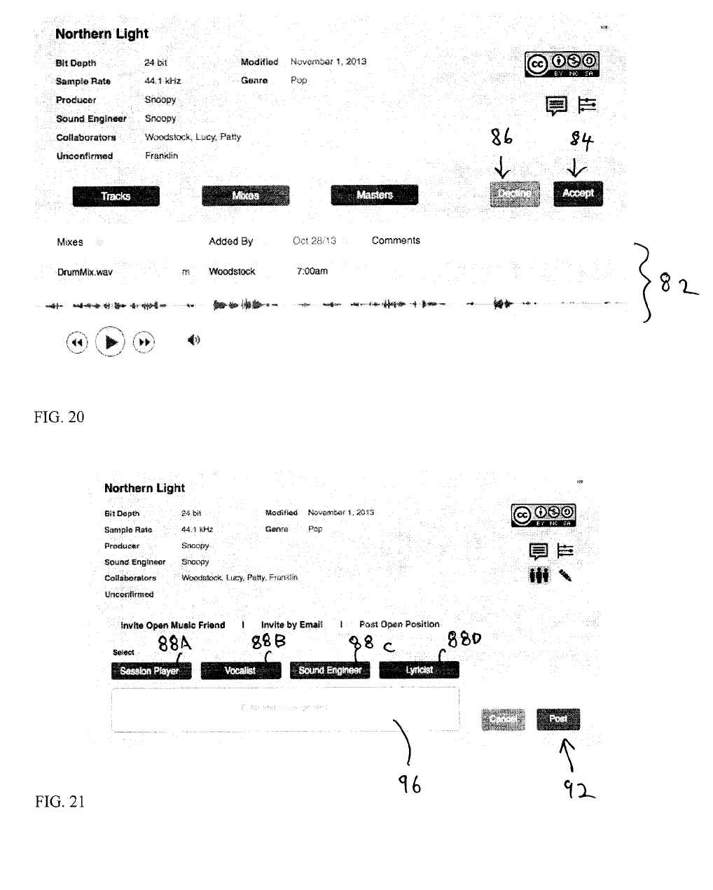

The customer can then click on the Project Icon 32C to display more information about the Project as well as various functions, including, as shown in FIG. 19, a Comment/SMS function 80 and a function 82 that enables the invitee to audition audio files, as shown in FIG. 20. At any time, the invitee has the option of clicking Accept 84 or Decline 86—i.e. to join the Project, or not. If an invitee clicks Accept 84: (i) he or she is added to the list of collaborators for the Project; (ii) he or she is added to the Producer/Inviter's Friends List; (iii) the Producer/Inviter is added to the invitee's Friends List; (iv) the invitee receives copies of all the relevant (permissioned) audio files in his/her client side component of the system via the File Synchronization function, discussed later.

### Responding as a Non-Customer

If the invitee is a non-customer, he or she will receive an email with a link to the relevant Project, however, the recipient will first be connected to the Site's registration process, so personal data can be collected and authenticated, and the recipient can be added as a new customer. Once the recipient has become a customer, the functionality described above is the same.

### Posting an Open Position

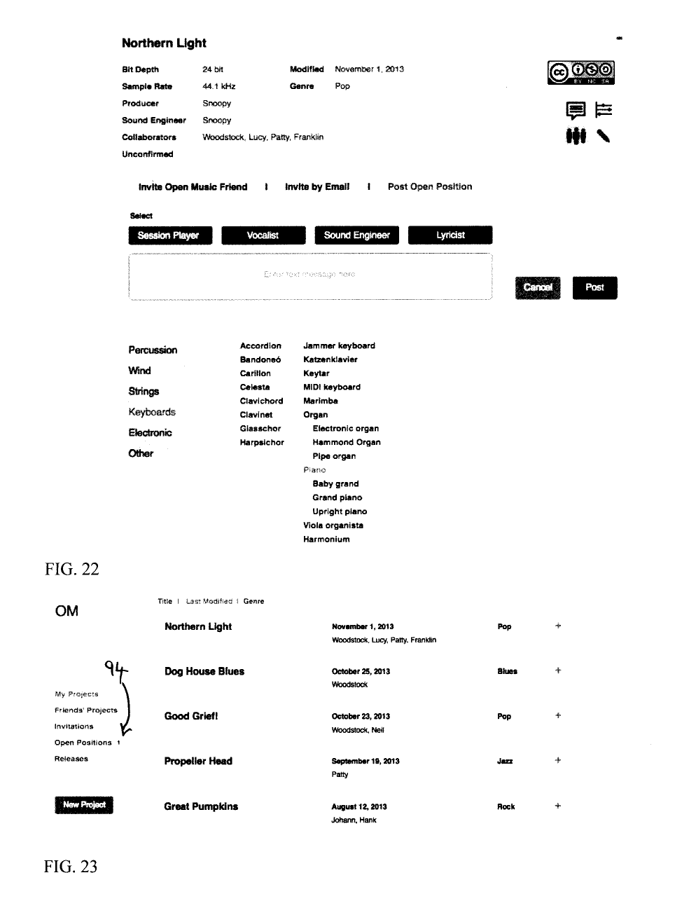

As previously mentioned, Posting an Open Position is one of three options for attracting collaborators. It involves the following steps:
After clicking the Collaborator button 56, the customer selects “Post Open Position” 70 and the Site displays information and several functions, as shown in FIG. 21
The customer selects the appropriate one of buttons 88A-88D to indicate whether he/she is advertising for a Session Player, Vocalist, Sound Engineer or Lyricist. The customer can then add a text message in a text box 90, and click the Post button 92 to post (or advertise) the position to other customers
After clicking, for example, a Session Player button, the customer is presented with additional, more specific choices that can be made with respect to the required talent being sought, as shown in FIG. 22

To indicate a new posting, flag 94 appears next to the Open Positions filter, as shown in FIG. 23.

### Respond to Open Position

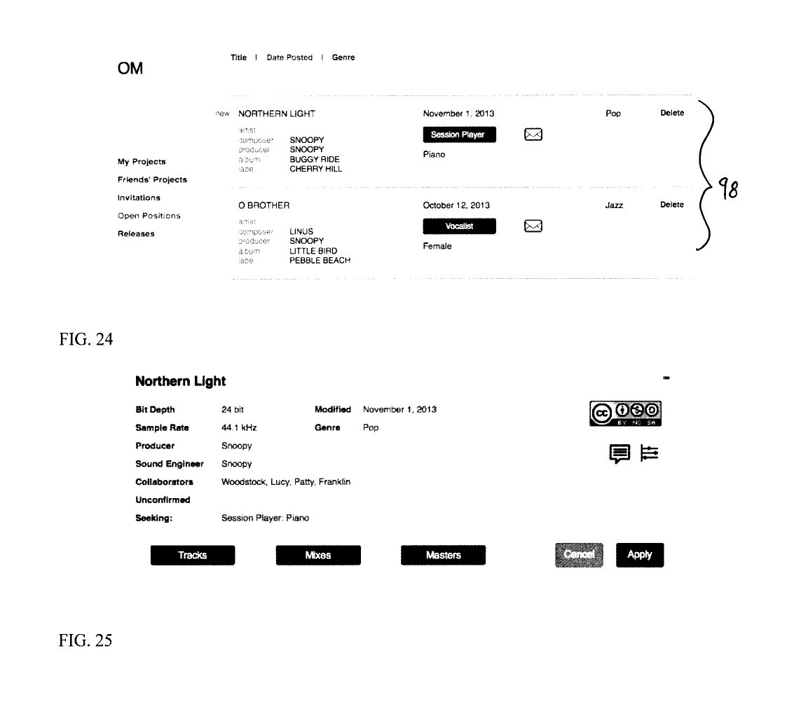

A customer can investigate and respond to an Open Position. Step one is to click on the Open Positions Filter to display a list 98 of Open Positions, as shown in FIG. 24. Customers may pre-filter the types of Open Positions that appear on their Site pages by selecting one or several filters based on criteria inter alia: genre, sub-genre, location of person posting, skill level of person posting, collaborators, talent requested by the person posting (eg. type of vocalist), whether or not cash or royalties are offered as remuneration, and other Project descriptors.

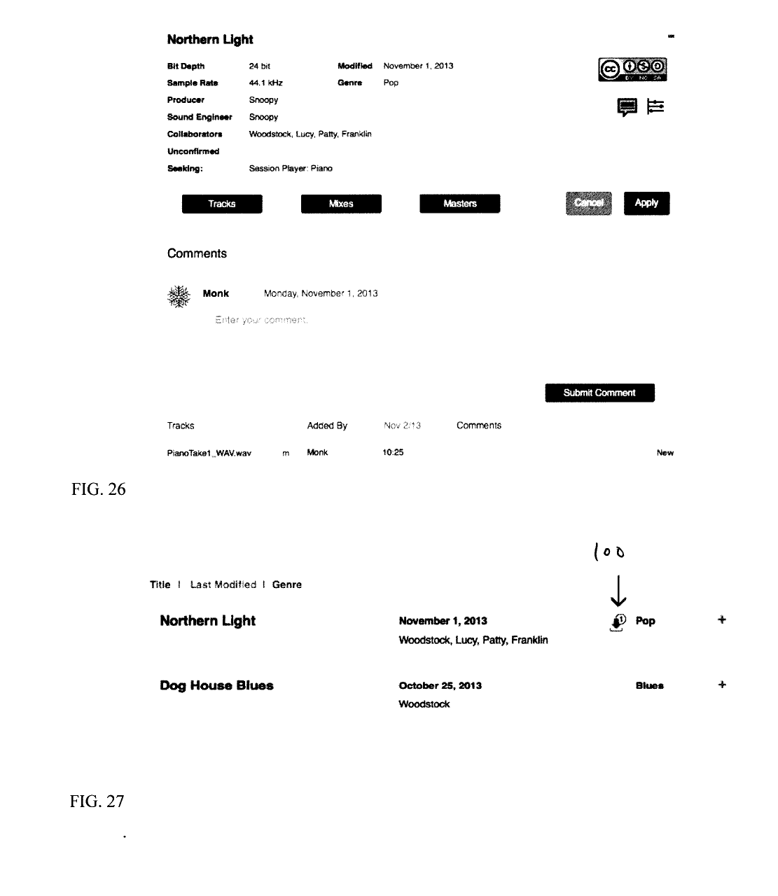

When clicked, the Open Position icon will display, as shown in FIG. 25, additional information and functions. The customer responding to the Open Position may apply for the Open Position by uploading sample work and submitting comments, as indicated in FIG. 26.

### Review Open Position Submission

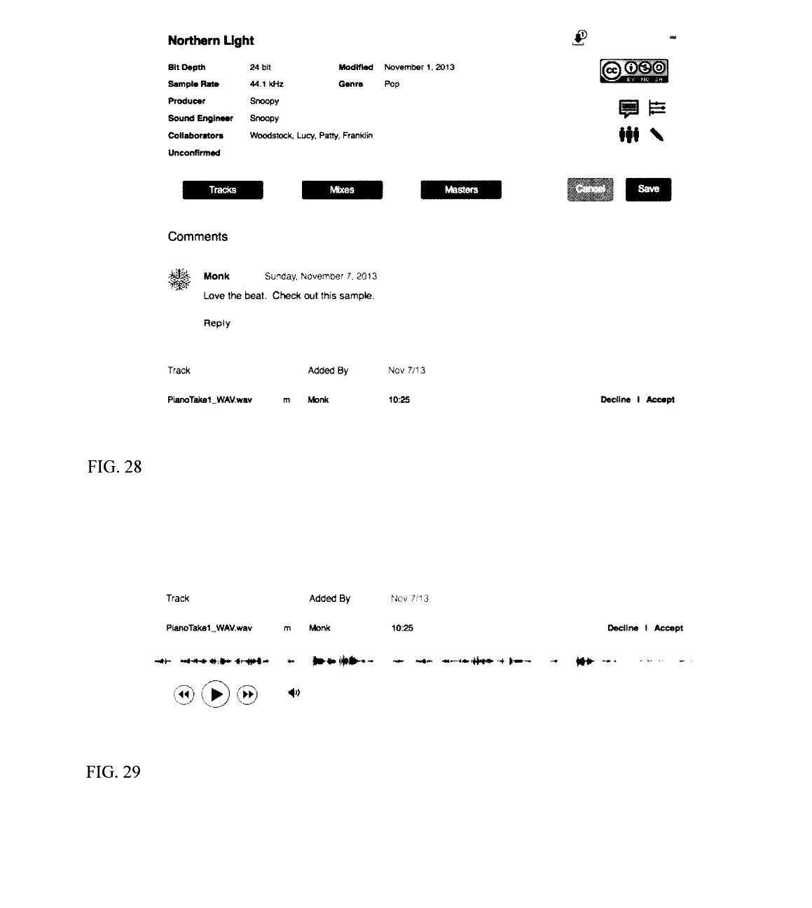

Customers who post Open Positions are alerted to responses and submissions to their postings by a flag 100 in the Project Icon on the Project page of their Site, as shown in FIG. 27. From this point, the customer can review and respond to the submission by:
Clicking on the Project Icon flag to display, as shown in FIG. 28, the comments and sample audio work submitted by the customer responding to the Open Position
Auditioning the submitted work, by selecting the work in the list, which activates a media player, as indicated in FIG. 29
Clicking Decline or Accept

As with the process of inviting a Friend, acceptance to a Project results in:
the customer who submitted work for review (the “Submitter”) is added to the list of collaborators for the Project
the Submitter and Producer/Inviter are added to the Friends Lists of one another
the Submitter receives copies of all the relevant (permissioned) audio files in his/her client side component of the portal via the File Synchronization function

### File Synchronization

All customers on the Site are provided with file synchronization (sync) functions. File sync operates on both client and web server platforms using technology and/or protocols such as WebDav http://en.wikipedia.org/wiki/WebDAV to ensure that collaborators can share, update, and delete audio files—and, in effect, maintain version control and permissioning for those files. For example, if one collaborator uploads a new audio file to a Project, that file is added to the Project on a web server and then copied, via an electronic file transfer method, to the desktop clients (eg. Windows, OSX, Linux) of all collaborators in the Project.

File sync is an automatic function that is enabled for each Project as a result of joint or shared participation or collaboration. A customer who is invited to collaborate in a Project, and who accepts such an invitation, is “permissioned” by the system to receive all or part of the portfolio of audio files associated with that Project. The same applies for a customer who responds to, and is accepted for, an Open Position.

### Edit Project

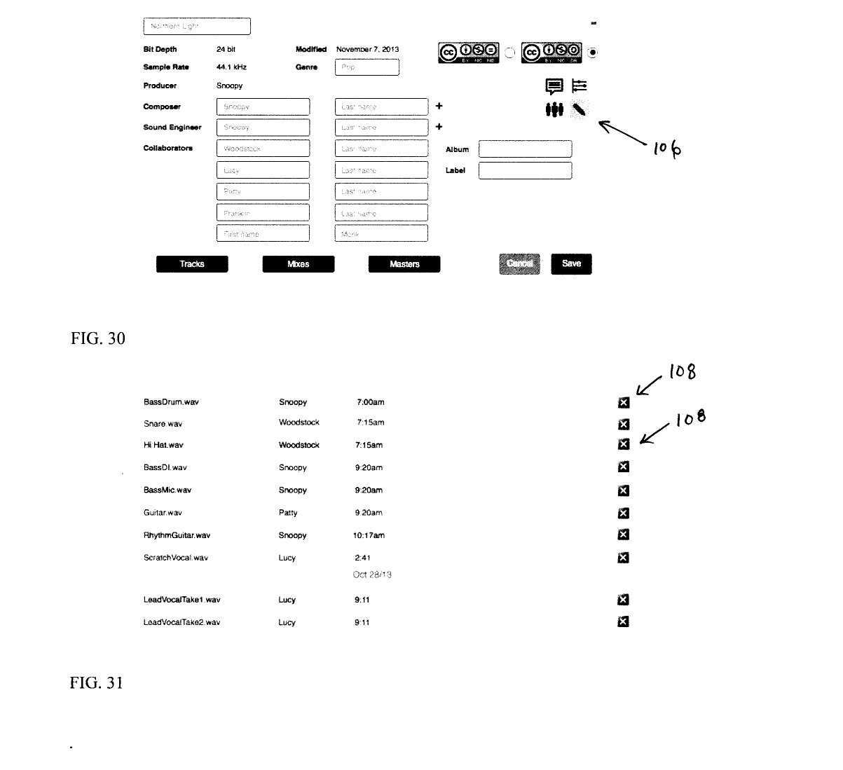

A Project's metadata can be updated and deleted by the Producer, and audio files can be deleted, using the Edit function. By clicking the Edit Icon 106, which resembles a pencil, in the Project page, as indicated in FIG. 30, the customer gains access to textbox fields and audio files, as in FIG. 31. Files can be deleted by selecting the delete box 108 associated therewith on the file listing.

### Timeline

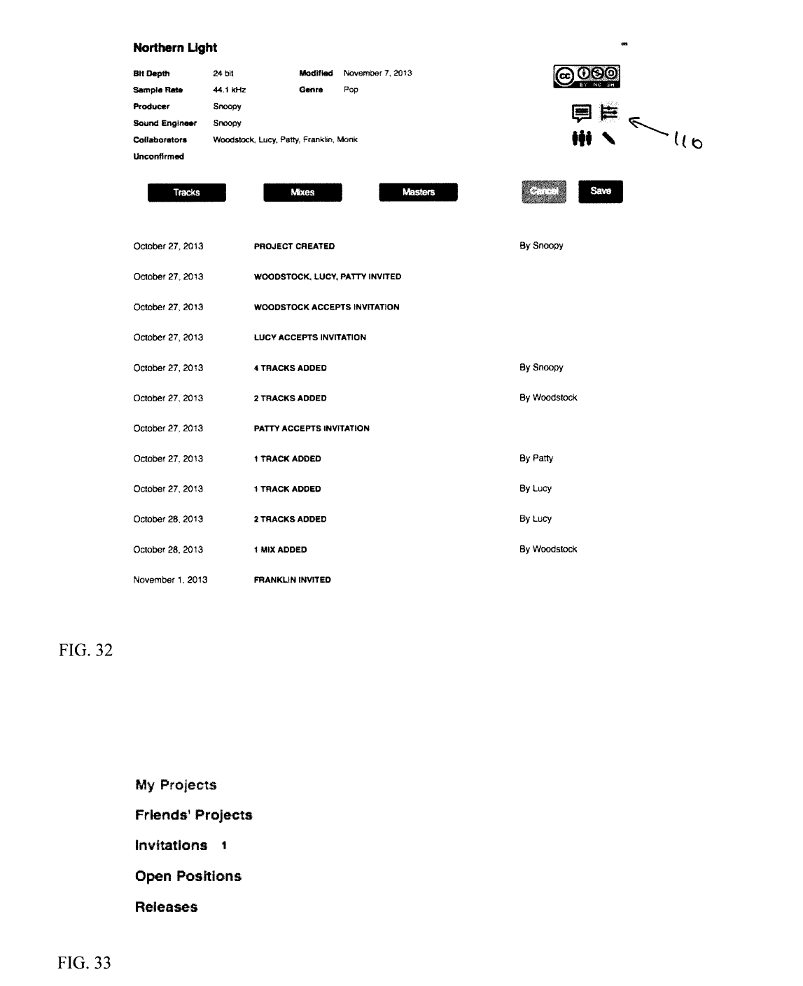

Customers may view and gain access to a chronological list of events using the Timeline function. By clicking the Timeline Icon 110, which resembles an abacus or stylized Gantt chart, the customer can review the date, time, actions, and events (and related data) with respect to a particular Project, all as shown in FIG. 32.

### Comments

Customers can use a Comment/SMS function to enter and send textual information to each other, individually, and to groups of other customers and collaborators.

### Project Filters

There are five Project categories as follows:
My Projects—i.e. Projects created by the User.
Friends' Projects—i.e. Projects created by Friends of the User, where the User is a Collaborator.
Invitations—i.e. Projects created by Friends of the User or other Users, where the User is being invited to join the Project as a Collaborator.
Open Positions—i.e. Projects created by Friends of the User or other Users, where all other Users on the Platform are invited to apply for a position as a Collaborator.
Releases—i.e. Projects created by the User and/or Projects on which the User has Collaborated, where the Project (or a Master from such Project) has been published and released.

For each Project Category there is Project Filter. Each Project Filter is represented as a button or text button. The five Project Filters, shown in isolation in FIG. 33, are listed on the left side of the Project Home Page, and on several other pages on the Site.

By clicking a Project Filter, the User can render on screen only those Projects having that particular Project Category's data characteristics. Each Filter can be in one of two positions: on (engaged), or off (unengaged). If one Project Filter is on, the other four are off. To indicate the on position, a Project Filter is rendered in blue.

The purpose of the Project Filters is to enable the User to render on the page a limited number of Projects or sets of Projects from the total database of Projects.

### Project Sort Buttons

Project Icons are listed and displayed on a Home Page in three types of order:
By title—an alphanumeric sort
By the date on which the Projects were last modified a chronological sort
By genre an alphanumeric sort

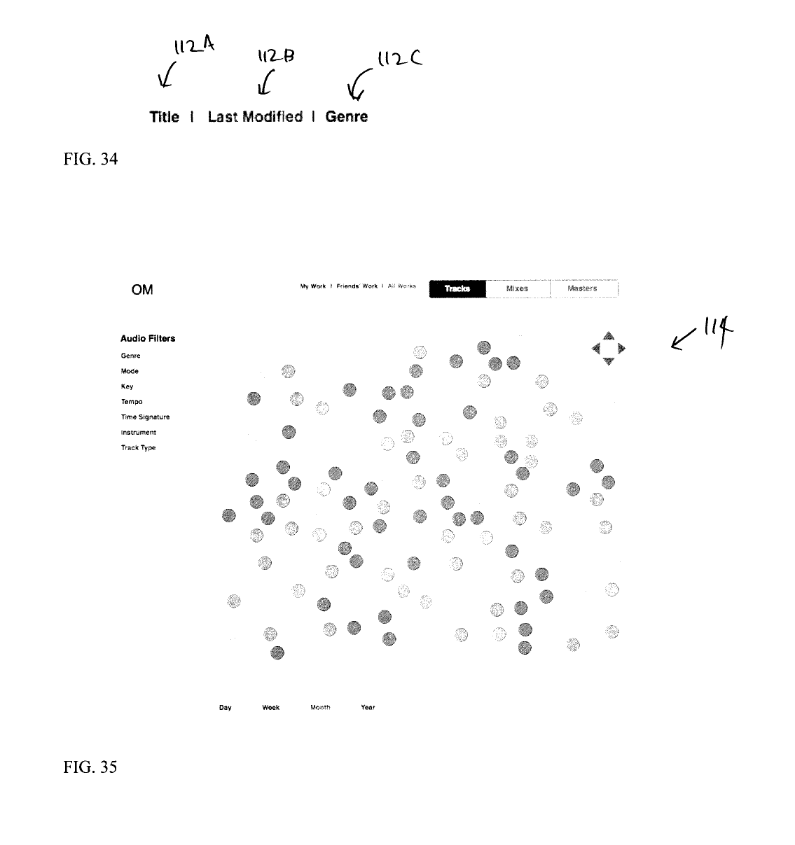

A customer can activate any one of the Project Sort buttons 112A, 112B, 112C, shown in isolation in FIG. 34, by clicking it. The buttons can be activated individually or in combination. They are activated by clicking once, and deactivated by clicking a second time.

### Music Map Module

As one aspect, the Music Map 114 is a dynamic, graphical display of audio files. The customer can observe sets of audio files represented graphically (eg. in a scatterplot graph), where each audio file is displayed as a geometric shape—i.e. an Audio File Icon—and is positioned on x and y axes.

The x and y axes can be assigned specific metrics or attributes. For example, in FIG. 35, the x axis represents time and the y axis represents the degree of energy in the audio recording.

Although not shown, it is also possible to introduce a third (z) axis. One way in which this could be done is to render the audio file icons in different sizes, to represent the magnitude of the z component.

The attribute assigned to the z axis can be selected from multiple possible attributes: popularity, danceability, acousticness, etc.

The customer can organize and display Audio File Icons according to multiple data categories including:

| | |
|---|---|
| genre | time signature |
| mode | instrument |
| key | vocal type |
| tempo | track type |

Each data category corresponds to selector buttons—i.e. Audio Filter Buttons—that, when activated, identify audio files with the selected data-set and display them as Audio File Icons.

The Music Map can also organize and display audio files according to:
chronology—i.e. the time and date it was uploaded
whether they are described as a Track, Mix, Master, or Release
author (creator)

### Audio File Search and Discovery

The customer can use the system of multiple Filter Buttons, based on the data categories described earlier, to activate a search and discovery process for specific subsets of the audio file repository.

The taxonomy and display is dynamic insofar as a customer can select one or more data categories to serve as filters for the repository of audio files. For example, a customer can click an Audio Filter Button to search the repository for audio files classified as “blues”, and only Audio File Icons representing recordings in the “blues” genre will appear on the screen. A customer can click additional Filter Buttons—for example, a button can select and filter only those audio files uploaded by Friends.

The repository can be filtered according to multiple combinations of data category such that only audio files meeting the customer's selected criteria are displayed. For example: blues, in the key of E, in 4/4 time, played on harmonica, created by Friends.

### Audio Matching

The system of multiple filters can also be used to match one audio file to others based on the relative similarity of their respective data-sets. A customer can select one audio file from the repository and use its data-set as a baseline to identify and display other audio files in the repository with similar data-sets. This is called Audio Matching.

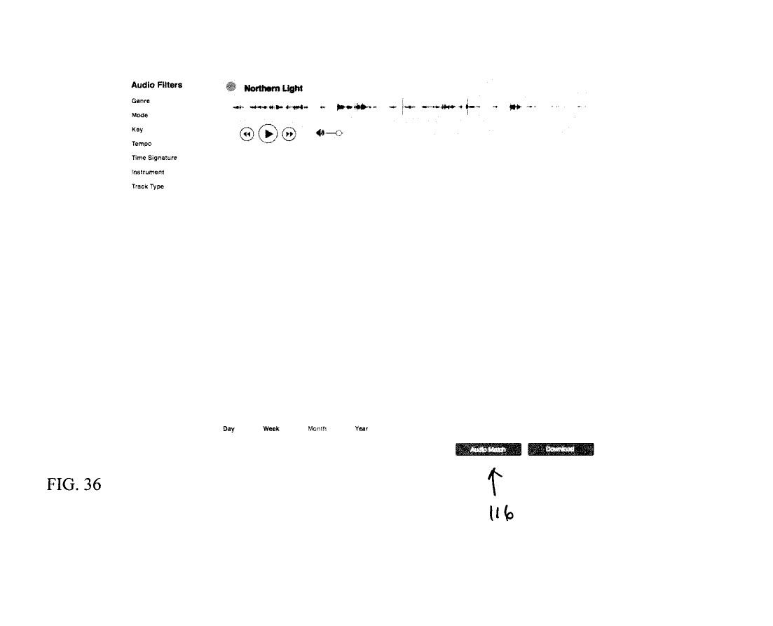

The customer can initiate an Audio Match, with reference to FIGS. 36,37 by:
i) selecting and clicking an Audio File Icon, that is, one of the points on the Music Map to identify the target audio file against which other audio files' data will be compared.
ii) clicking the Audio Match button 116 to engage the Audio Matching mechanism; and
iii) clicking one or multiple Filter Buttons 118A-E.

The above process activates an algorithm that compares the data-set of the target audio file with the data-sets of other audio files in the repository, and then renders and displays only those Audio File Icons corresponding to audio files where the data-sets are calculated to be more similar on a scale of similarity.

The customer can adjust the Audio Matching mechanism to determine the number of matches displayed. Moreover, the system can graphically represent measures of similarity between the target audio file and matched audio files by the relative positions of Audio File Icons on a 2 or 3-dimensional graph—i.e. Audio File Icons closer to the target are more similar, and those that less close are less similar.

FIG. 36 shows the result of the selection of an audio file on the Music Map.

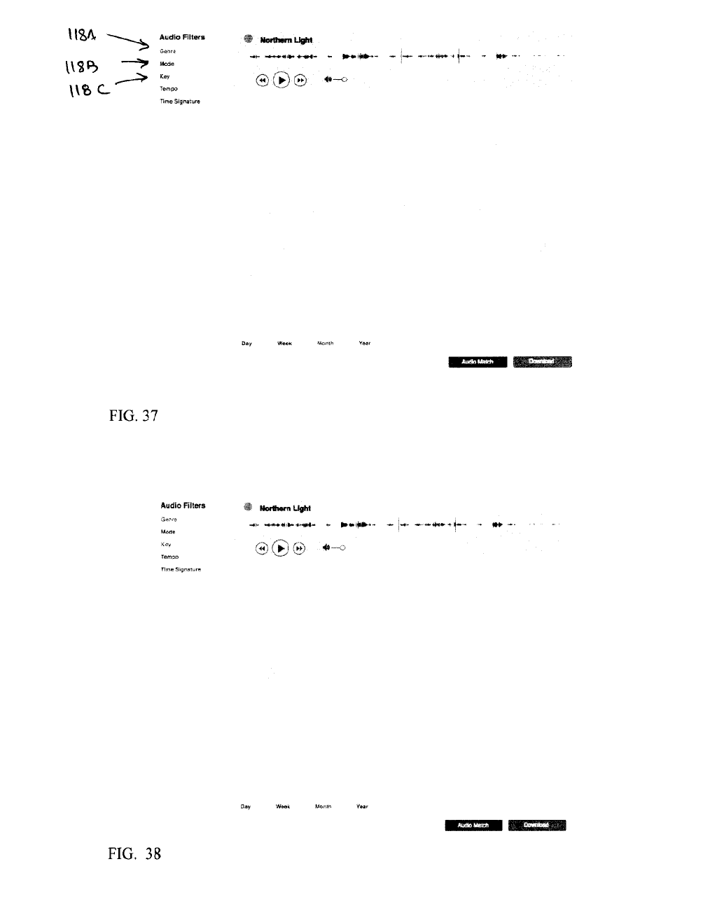

FIG. 37 shows the result of the selection of the Audio Match button

FIG. 38 shows the result of the selection of the filter Genre, to wit, only those audio file icons from the same genre appear

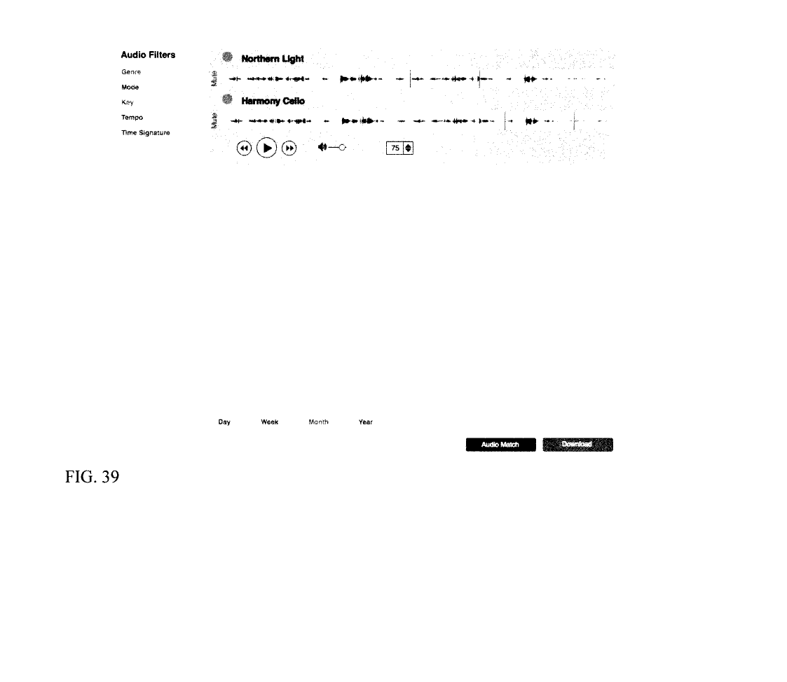

FIG. 39 shows the result when one of the “matching” audio files is clicked, namely, “Harmony Cello”, which is automatically rendered in the audio player with the target.

### Open Position Search and Discovery

Just as Open Positions can be created and responded to within the Project Management Module, Open Positions can also be rendered and displayed on a Music Map.

On a Music Map, an Open Position can be represented by, and displayed as:
a single geometric shape; or
a single geometric shape in association with other similar shapes representing a Project.

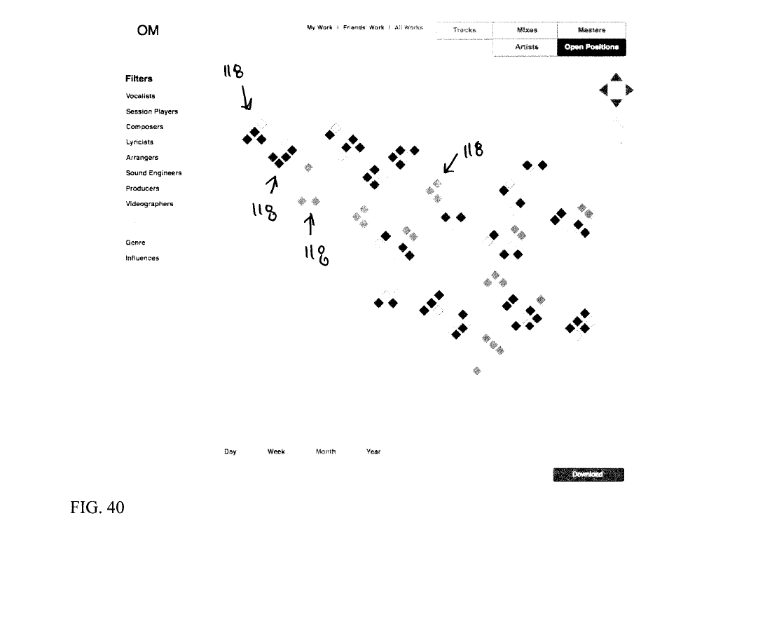

In FIG. 40, each collection 118 of diamond shapes represents a separate Project and is called a Project Icon. Each separate shape within a Project Icon represents a different collaborator's audio file. Each shape that is empty—i.e. white with a coloured border—represents an Open Position and is called an Open Position Icon.

Customers may pre-filter the types of Open Positions that appear on their Site pages by selecting one or several filters based on criteria inter alia: genre, sub-genre, location of person posting, skill level of person posting, collaborators, talent requested by the person posting (eg. type of vocalist), whether or not cash or royalties are offered as remuneration, and other Project descriptors.

As with Audio File Icons, Project Icons can be displayed graphically on a Music Map according to x and y axes, where x and y represent different metrics or attributes. In FIG. 40, the x axis represents time—specifically, the date and time when each Project was first uploaded to the Site—and the y axis represents the number of prospective collaborators that have applied to the various Open Positions.

### Recommendation Engine

The system records and organizes customer usage data so that a customer's preferred types of audio files, Projects, Open Positions, collaborators, and the associated metadata, are calculated algorithmically to generate customer recommendations for: Projects, Open Positions, and collaborators.

### Mobile Application Module

This module is a digital distribution platform and crowdsource rating system for works—specifically, Releases. It incorporates several features and functions from the Music Map but within a mobile device form factor. Users and end-users of the mobile application can audit, stream, score and share Releases, and manipulate and render audio files in various ways including download.

The mobile application includes a payment services mechanism to enable end-users to subscribe to the system and thereby gain access to Works presented.

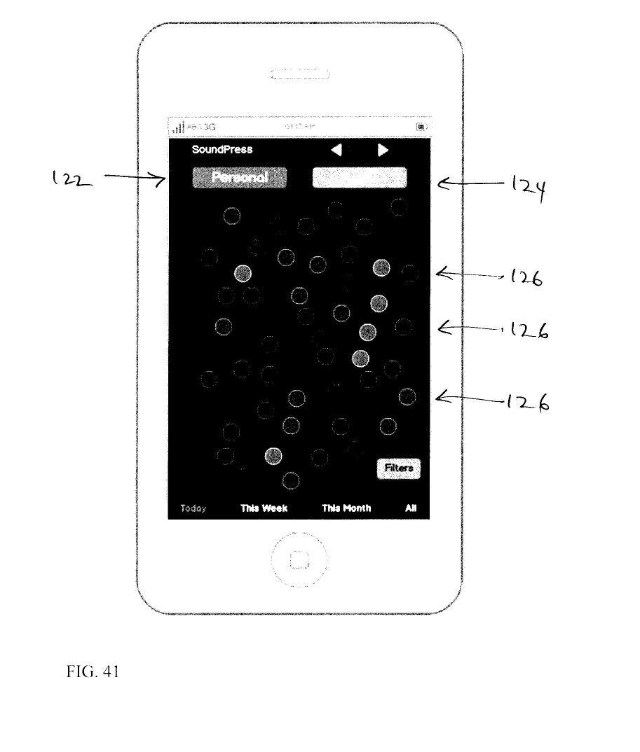

An example of the primary user interface is shown in FIG. 41

The primary user interface functions as follows.

With reference to FIG. 41, the Personal button 122 and Public button 124 represent two related archives of audio files. When a user or end-user clicks “Public”, the Public archive becomes active and its related button is rendered in colour, the Personal archive becomes inactive and its related button is rendered in grey.

Within the Personal archive are Audio Files that a User or End-User has chosen from the Public archive.

From a Personal archive, Works can be Shared, streamed and downloaded.

Within the Public archive is the complete set of Works that have been mastered and released by Users of the Site, each being represented by an icon 126. From the Public archive, Works can be streamed and added to one's Personal archive.

If a User or End-User touches an Icon on the screen, the Audio File is streamed and played.

When a User or End-User drags an Icon (eg. with a fingertip), up and down the vertical axis of the screen, the Audio File is effectively assigned a score or ranking relative to other Audio Files on the screen.

The User or End-User may apply touch screen commands (eg. for iOS and Android) to zoom in and out of the screen.

The User or End-User may drag the screen horizontally from left to right to reveal Icons created more recently; and drag the screen horizontally from right to left to reveal Icons created further in the past.

The User or End-User may drag the screen from top to bottom to reveal Icons with higher preference scores; and drag the screen from bottom to top to reveal Icons with lower preference scores.

The User or End-User may touch any one of the time related Selectors at the bottom of the screen (Today, This Week, This Month, All) to limit the number of visible Icons on the screen according to when the related Audio File Masters were released. For example, touching the “Today” Selector will render only those Icons related to Audio Files released today.

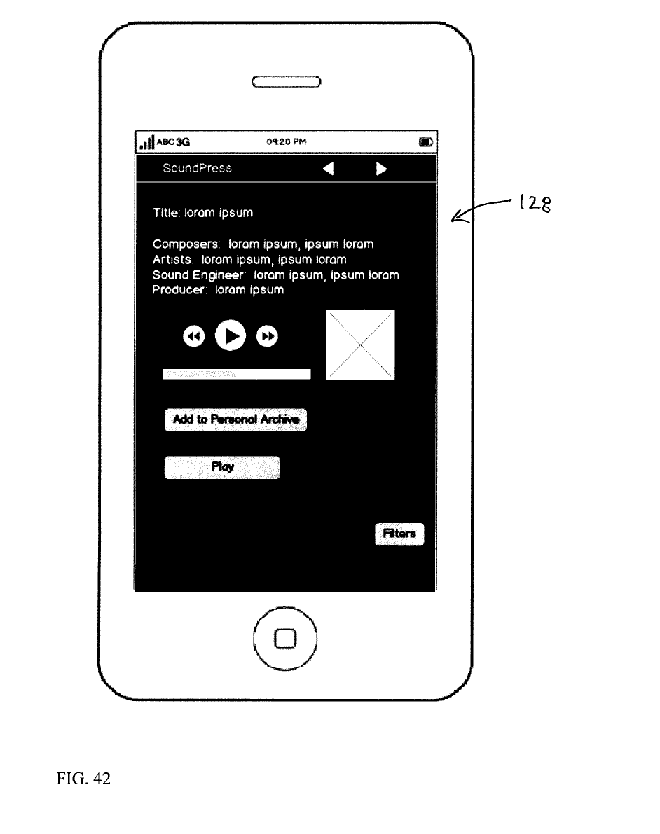

If the User or End-User touchs an Icon for longer than 3 seconds, or applies an alternate command, a Modal Window opens to reveal data and additional functions that correspond to the related Audio File. An example of a Modal Window 128 for an Audio File located in the Public archive is shown in FIG. 42.

The Modal Window includes the following functions:

| | |
|---|---|
| Add to Personal Archive | self explanatory |
| Play (i.e. stream) | self explanatory |
| Filter | links the User or End-User to a screen |
| | displaying a Music Map type screen |
| | including Audio Filters |
| Audio Player | for stopping and starting, and for moving the |
| | virtual play head to the start and end of an |
| | Audio File. |

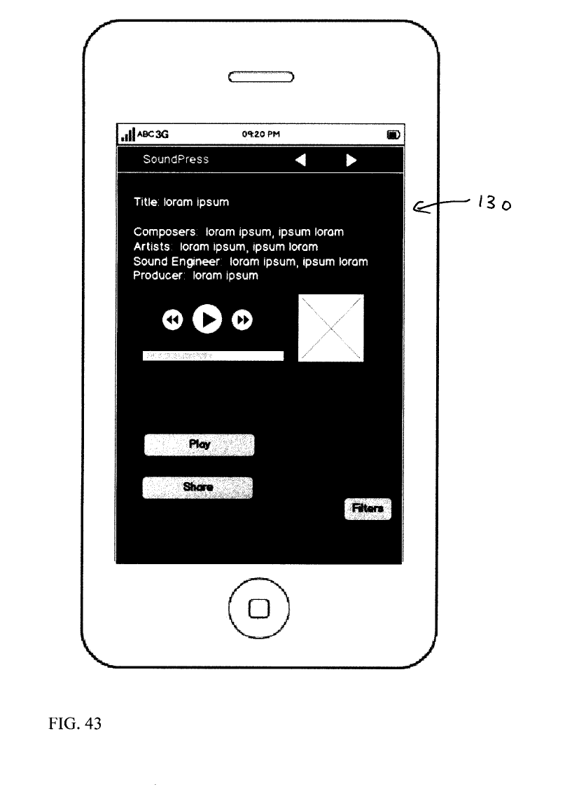

An example of a Modal Window 130 for an Audio File that is located in a Personal archive is shown in FIG. 43.

The main difference is that the above Modal Window, for an Audio File located in a Personal archive does not include an “Add to Personal Archive” function; but it does include a “Share” function. The Share function enables the User or End-User to send a copy of the Audio File, or an alert referencing the Audio File, to another User or End-User (see “Score, Post and Share” in Open Music Networks Prototype: Product Requirements Specification).

Whereas specific embodiments are herein shown and described, it will be evident that variations are possible. Accordingly, the invention should be understood to be limited only by the accompanying claims, purposively construed.

1. A system for facilitating the collaborative creation of music, the system comprising:
a taxonomy for classifying a music recording.

2. A system according to claim 1, further comprising:
a computing functionality that provides for the dissemination of identities of recordings
that have been classified in accordance with the taxonomy and the classifications thereof.

3. A system according to claim 2, wherein the functionality allows users to identify recordings that have been classified in accordance with the taxonomy.

4. A system according to claim 3, wherein the functionality allows users to classify recordings in accordance with the taxonomy.

5. A system according to claim 1, wherein the computing functionality is accessible via a communications network and provides for the dissemination of identities and classifications by the communications network.

6. A system according to claim 1, wherein the recordings are classified by proprietor and one or more of presence, author, genre, instrument, vocal type, license type, sample rate, time signature, file format type, the type of digital audio device(s) used in production, mode, key, tempo and musical influences.

7. A system according to claim 6, wherein the classifications include, for presence, notation and performance.

8. A system according to claim 2, wherein the recordings include compositions, arrangements, and combinations and permutations thereof.

9. A system according to claim 6, wherein the functionality is further adapted to permit users to identify music projects and to associate music recordings to projects.

10. A system according to claim 9, wherein, in respect of each project to which recordings have been associated having differing proprietors, the functionality provides a mechanism by which those proprietors can submit votes on a division of rights in a Master defined by those recordings.

11. A system according to claim 10, wherein the vote on a division of rights is a vote for a portion of the rights in the Master to each of the voting proprietors.

12. A system according to claim 11, wherein, if the voting proprietors vote in unanimity on an allocation of rights, such voting result is deemed to be a vote in favor of that allocation.

13. A system according to claim 11, wherein, if the voting proprietors vote in unanimity on an allocation of rights, such voting result is deemed to be a vote in favor of that allocation and the functionality creates a document evidencing an agreement thereby made reflecting such allocation.

14. A system according to claim 11, wherein, if the vote of the proprietors is not unanimous, the functionality provides for a reconsideration step, wherein the facility: disseminates to the voting proprietors, the allocations voted for by each proprietor along with a calculated allocation for each proprietor that is a reflection of prior votes; prompts each voting proprietor to select a choice from a group of choices including one or more of:
agree with the allocations voted for by any one of the other voting proprietors; and
agree with the calculated allocation.

15. A system according to claim 14, wherein the calculated allocation is an average.

16. A system according to claim 14, wherein the group of choices also includes one or more of:
vote in favor of the previous allocation by that proprietor; and
enter a new allocation.

17. A system according to claim 1, wherein the functionality further provides for the dissemination of the recordings.

18. A system according to claim 1, wherein the functionality provides for a secure portal accessible via the Internet.

19. A system according to claim 2, wherein the functionality provides for dissemination of the recordings and the classifications by a 2 or 3-dimensional scatterplot graph wherein each point represents a music recording, each of the dimensions of the plot being associated with a relatively highly-variable characteristic of the recording.

20. A system according to claim 19, wherein the dimensions of the scatterplot graph are selected from one or more of: time of upload, last upload, time of creation, time of upload, last upload, last visit, energy, number of downloads, number of times played, danceability, speechiness, liveness, acousticness, valence, intensity, likes and degree of correlation to preferences.

21. A system according to claim 19, wherein the functionality allows for the inventory of recordings shown in the scatterplot graph to be filtered by one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, numbers of recent visits, total visits, state of completion, number of plays, number of projects in which a recording is included, likes and degree of correlation to preferences.

22. A system according to claim 19, wherein the appearance of the points in the scatterplot graph varies as a function of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, numbers of recent visits, total visits, state of completion, number of plays, number of projects in which a recording is included, and likes.

23. A system according to claim 19, wherein the appearance of the points in the scatterplot graph varies as a user-selectable function of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, numbers of recent visits, total visits, state of completion, number of plays, number of projects in which a recording is included, and likes.

24. A system according to claim 19, wherein selection of a point in the scatterplot graph triggers one or more of the playback of the recording and a display of the details of the classification of the recording.

25. A system according to claim 22, wherein the functionality is further adapted to permit a visitor to the portal who has identified a project to define music recordings desired in respect of the project and the state of completion is defined automatically as a function of the difference between the desired music recordings defined and the music recordings associated therewith.

26. A system according to claim 25, wherein the functionality is further adapted to permit a visitor to the portal who has identified a project with which a music recording has been associated by another to dissociate that recording.

27. A system according to claim 9, wherein the functionality is further adapted to disseminate identities of projects and music recordings associated therewith.

28. A system according to claim 27, wherein the functionality provides for dissemination of the identifies of projects and music recordings associated therewith by a 2 or 3-dimensional scatterplot graph wherein the point are collections of icons, each collection representing a project, an icon being provided for each music recording associated to a project and each music recording desired for the project

29. A system according to claim 28, wherein the dimensions of the scatterplot graph are selected from one or more of: time of upload, last upload, time of creation, time of upload, last upload, last visit, energy, number of downloads, number of times played, danceability, speechiness, liveness, acousticness, valence, intensity, likes and degree of correlation to preferences.

30. A system according to claim 28, wherein the functionality allows for the points shown in the scatterplot graph to be filtered by one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, numbers of recent visits, total visits, state of completion, number of plays, likes and degree of correlation to preferences.

31. A system according to claim 28, wherein the appearance of the icons in the scatterplot graph varies as a function of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, numbers of recent visits, total visits, state of completion, number of plays, likes and degree of correlation to preferences.

32. A system according to claim 28, wherein the appearance of the icons in the scatterplot graph varies as a user-selectable function of one or more of: proprietor, friendship or contact status, key, time signature, tempo, mode, genre, state of completion, instrument, vocal type, track type (melody, ostinato, harmony, etc.), presence [notation or performance], author, license type, musical influences, time of creation, physical location of the author/producer, numbers of recent visits, total visits, state of completion, number of plays, number of projects in which a recording is included, and likes.
